(19) United States
(12) Patent Application Publication
(10) Pub. No.: US 2005/0094551 A1
(43) Pub. Date: May 5, 2005

(54) Processor instruction for DMT encoding

(75) Inventors: Mark Taunton, Cambridge (GB); Timothy Martin Dobson, Cambridge (GB)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 10/949,466

(22) Filed: Sep. 27, 2004

Related U.S. Application Data
(60) Provisional application No. 60/505,721, filed on Sep. 25, 2003.

(51) Int. Cl. H04J 11/00

(52) U.S. Cl. 370/206

(57) ABSTRACT

A method, apparatus and processing instruction for performing DMT encoding substantially simultaneously on one tone or multiple tones comprises the steps of: (a) using a first input operand comprising one or more bit-group data values, each to be encoded for one or more tones; (b) using a second input operand comprising one or more bit-group size values corresponding to the bit-group data values in the first input operand; and (c) generating an output comprising a result of encoding the bit-group data value or values from the first input operand by mapping each of the bit-group data values from the first input operand onto a location in a constellation as determined by the corresponding bit-group size value or values from the second input operand. One embodiment for performing DMT encoding substantially simultaneously on first through fourth tones using a SIMD instruction includes at least the following steps: 1) using a first input operand that includes a 64-bit value having first through fourth half-word fields, each of the first through fourth half-word fields includes a bit-group data value to be DMT encoded for one of the first through fourth tones; 2) using a second input operand that includes a 64-bit value having first through fourth half-word fields, the first through fourth half-word fields define bit-group size values of the first through fourth half-word fields in the first input operand; 3) generating an output including a 128-bit value having first and second 64-bit values each having first and second 32-bit fields, each of the 32-bit fields representing a result of DMT encoding a corresponding bit-group data field from the first input by mapping the first input operand onto a predetermined constellation as determined by the bit-group size values from the second input operand.

### CROSS-REFERENCE TO RELATED APPLICATIONS

This application claims priority from U.S. provisional application No. 60/505,721 entitled “SIMD Instructions for DMT Encoding” by Mark Taunton and Timothy Dobson, and filed on Sep. 25, 2003 which is incorporated by reference herein in its entirety

### BACKGROUND OF THE INVENTION

1. Field of the Invention

The present invention relates generally to Discrete Multi-Tone (DMT) encoding and to the design of instructions for processors. More specifically, the present invention relates to a system, method and processor instruction for DMT encoding.

2. Related Art

Discrete Multi-Tone (DMT) modulation is now used in many applications such as Digital Subscriber Line (DSL) (e.g. asymmetric DSL (ADSL), very high rate DSL using multi-carrier modulation (VDSL-MCM)) and digital broadcasting (e.g., Coded Orthogonal Frequency Division Multiplexing (COFDM) as used in digital video broadcasting (DVB) and digital audio broadcasting (DAB) standards).

DMT is usually implemented using Quadrature Amplitude Modulation (QAM). In QAM, a binary coded value V of N bits of data to be transmitted is encoded by choosing one of 2^{N} points from a regular 2-dimensional constellation or matrix of possible values (i.e. of possible (X,Y) locations), in accordance with the value of V which can range from 0 through 2^{N}-1 when considered as a binary-coded number. The location (X, Y) of the point within the QAM constellation to which the value is mapped defines a 2-dimensional (complex) amplitude to be applied by modulation to a segment of a sinusoid signal (a ‘tone’). This tone is subsequently transmitted, so as to carry the N bits of information in the value V.

In the simplest case of DMT, a block B comprised of M bits to be encoded is broken up into multiple smaller groups of bits, which form binary-coded values Vi of Ni bits (V1 of N1 bits, V2 of N2 bits, etc.), where the total of N1, N2, etc. is M. In some cases (e.g. where trellis modulation is used to increase the error-resilience of the system), extra bits may be introduced into the binary-coded values Vi, in addition to the bits extracted from the block B; in such a case the sum of N1, N2 etc. would be greater than M by the number of extra bits introduced. Different tones Ti (T1, T2, etc.) are modulated separately in accordance with the 2-dimensional modulation amplitude selected using the Vi values, and summed together for transmission. The frequencies Fi of the different tones Ti (F1, F2, etc., which for the general case of DMT can occur in arbitrary order, and not necessarily in order of increasing frequency) are offset from each other by integer multiples of a basic frequency, such that they can be demodulated independently at a receiver. The composite waveform built from the sum of the individual tone contributions is then transmitted for a finite time before the process is repeated on the following block of bits. Each transmitted waveform, representing a single block of encoded bits, is commonly known as a symbol. In systems using DMT, the rate of creation of symbols is typically between a few hundred and a few thousand symbols per second (e.g., in ADSL the symbol rate is approximately 4059 Hz).

The subdivision of the block B into the individual bit-group data values Vi need not allocate the same number of bits to each group, i.e. V1 need not contain the same number of bits as V2 or V3, etc. Instead, each tone Ti has associated with it its own bit-group size value Ni, so some tones may be encoded to carry more bits than other tones, using larger constellations (sets of possible (X,Y) locations) for those tones which carry more bits. This flexibility is a key feature of DMT as used in applications such as ADSL and VDSL where the different frequencies of the transmitted tones may encounter different degrees of degradation on the path to the receiver, and there exists a two-way communication path such that this variation between tones observed at a receiver can be communicated back to the transmitter during an initialization process. By selecting the Ni values to be used, in accordance with the reliability of reception of the respective tones Ti, the receiving modem can make best use of the specific characteristics of the link.

In existing international and national standards for both ADSL (e.g., ITU-T recommendations G.992.1, G.992.2, G.992.3, and G.993.4, which are incorporated herein by reference in their entireties) and DMT-based VDSL (e.g., ANSI T1E1.4 VDSL (part 3: Multi-Carrier Modulation) and ITU-T Recommendation G.993. 1, which are incorporated herein by reference in their entireties), a common scheme is used for mapping the value of each group of bits Vi onto an (X, Y) position in the 2-dimensional constellation. The mapping varies according to a number of bits Ni which each group contains.

This selects the complex amplitude (X being the real part of the amplitude and Y being the imaginary part) that modulates tone Ti. This scheme is defined for different sizes of bit-groups (i.e., different individual values of the bit-group size Ni) from 1 bit per tone through 15 bits per tone, but could be extended in an obvious manner for larger values of Ni if required.

In summary, a transmitter implementing the general case of DMT will: (1) split an input data block B into component bit-groups; (2) if required, add extra bits (such as trellis bits) to some or all of the component bit-groups, to produce bit-group data values V1, V2, . . . , having respective bit-group size values (numbers of bits) N1, N2, . . . , each bit-group data value Vi being associated with a particular tone Ti (of sinusoid frequency Fi); (3) map each bit-group data value Vi onto the 2-D matrix specified by the associated bit-group size value Ni using the defined mapping for that bit-group size; and (4) use the X and Y coordinates of the mapped location for each value Vi to modulate the tone Ti of frequency Fi with which the respective bit-group Vi is associated.

In this context the term “DMT encoding” is used to mean the mapping of a group of bits V (a bit-group data value) onto a particular QAM constellation (the selection of which is determined by the number N of bits in the group, the bit-group size value) according to the binary-coded value of the bit-group V, along with the determination of the X and Y coordinates of the point in the constellation to which the value is mapped. This encoding process is specified exactly, for both ADSL and DMT-based VDSL systems, by the respective DSL standards. The most general version of this encoding is defined for ADSL2 (e.g., ITU-T standard G.992.3, section 8.6.3, which is incorporated by reference herein in its entirety), the other versions are strict subsets of that definition. While the standards specify the effect of the encoding, the detailed implementation of the encoding process is not itself specified.

In older designs for transmission systems using DMT (e.g., DSL modems) that are in general more hardware oriented, the DMT encoding of data, for subsequent modulation of tones for transmission, is typically performed by fixed-function logic circuits. However, such system designs are commonly hard to adapt for varying application requirements.

In order to increase flexibility in modem development and application, it has become more common to use software to perform the various functions in a DMT-based transmitting device. As the various performance levels (e.g., data rates) required of such devices increase, the pressure on the software to perform efficiently each individual processing tasks (e.g., DMT encoding) that make up the overall transmitter function likewise increases. Performing the DMT encoding operation purely in software is typically quite complex to implement. Using conventional instructions (e.g. bit-wise shift, bit-wise and, bit-wise or, etc.) it may take many cycles, or even tens of cycles, to perform DMT encoding for a single tone. In some circumstances there may be hundreds or even thousands of tones for which the associated data bits must be encoded, per transmitted symbol, and several thousand symbols per second may need to be transmitted.

The DMT encoding process can therefore represent a significant proportion of the total computational cost for a software-based DMT transmitter, especially in the case of a system where one processor handles the operations for multiple independent transmission channels (e.g., in a multi-line DSL modem in the central office). With increasing workloads (in respect of the average number of tones used in each transmission channel), it becomes necessary to improve the efficiency of DMT encoding of data in such software-based DMT transmitters.

Therefore, what is needed is a system and method that significantly reduce the number of cycles needed for performing DMT encoding of data in accordance with mapping schemes specified in international and national standards.

### SUMMARY OF THE INVENTION

According to the present invention, these objects are achieved by a system and method as defined in the claims. The dependent claims define advantageous and preferred embodiments of the present invention.

The embodiments of the present invention provide a method, apparatus and processing instruction for performing DMT encoding substantially simultaneously on multiple tones using a SIMD instruction. In general, the present invention comprises the steps of: (a) using a first input operand comprising a plurality of bit-group data values, each to be encoded for one of the plurality of tones; (b) using a second input operand comprising a plurality of bit-group size values corresponding to the bit-group data values in the first input operand; and (c) generating an output comprising a result of encoding the bit-group data values from the first input operand by mapping each of the bit-group data values from the first input operand onto a location in a constellation as determined by the corresponding bit-group size value from the second input operand.

In one embodiment, the first and second input operands each comprise a plurality of lanes, each lane comprising a number of bits. Each lane in the first input operand comprises a bit-group data value, and each lane in the second input operand comprises a bit-group size value corresponding to a bit-group data value in the first input operand. In one embodiment, the bit-group size values may vary from 0 to 15, where 15 is the number of bits in the largest constellation defined by the above-referenced standards. In another embodiment, the bit-group size values may each vary from 0 to 16. In an embodiment, each lane comprises 16 bits. The output of the present invention may further comprise a plurality of lanes, each lane comprising the result of encoding the bit-group data values from the first input by mapping the bit-group data values from the first input operand onto a constellation as determined by the corresponding bit-group size values from the second input operand. In one embodiment, each lane in the output comprises 32 bits. Each lane in the output may be further divided into two sub-fields, wherein a first sub-field represents an X coordinate of a point in the determined constellation and a second sub-field represents a Y coordinate of the point in the determined constellation.

In another embodiment, the first input operand comprises one lane for one bit-group data value and the second input operand comprises one lane for one bit-group size value corresponding to the one bit-group data value, and generates an output comprising a result of encoding the bit-group data value by mapping it onto a constellation as determined by the bit-group size value. In this embodiment, the present invention performs the DMT encoding for one bit-group data value for one tone.

In yet another embodiment of the present invention, the first input operand comprises a 64-bit value having four lanes: preferably, a first through fourth half-word fields, each of the first through fourth half-word fields including a bit-group data value to be encoded for one of the first through fourth tones, and the second input operand comprises a 64-bit value having four lanes: preferably, a first through fourth half-word fields, the first through fourth half-word fields defining bit-group size values for the first through fourth half-word fields in the first input operand. The generated output comprises a 128-bit value having four lanes, a first through fourth 32-bit tone fields, each of the 32-bit tone fields having a first and second 16-bit coordinate field, the tone fields representing a result of encoding a corresponding bit-group data field from the first input by mapping the first input data value onto a particular constellation point (defined by the first and second coordinate fields) as determined by the bit-group size values from the second input operand. In this embodiment, the present invention performs the DMT encoding for four bit-group data values for four tones. In an embodiment, the generated output 128-bit value may be further divided into two 64-bit fields, each 64-bit field comprising two lanes, each lane having a 32-bit tone-field.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a block diagram of a communications system in accordance with the present invention.

FIG. 2 illustrates a block diagram of a processor in accordance with one embodiment of the present invention.

FIG. 3A illustrates an instruction format for a three-operand instruction supported by the processor in accordance with one embodiment of the present invention.

FIG. 3B illustrates an instruction format for DMT encoding in accordance with one embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known processes and steps have not been described in detail in order not to unnecessarily obscure the present invention.

Embodiments of the present invention provide an instruction or an instruction mechanism (“the instruction mechanism”) that significantly reduces a number of cycles needed to perform a DMT encoding of data in accordance with mapping schemes specified in international and national standards. The instruction mechanism can also be used in other applications of DMT transmission where the same mapping scheme is used. Through use of SIMD techniques, the new instruction mechanism directly implements the DMT encoding process substantially simultaneously for a plurality of tones, where the number of bits being encoded for each tone is specified separately and can vary independently, for example, between 0 and 15 bits. In one embodiment, the instruction mechanism operates in software on a processor in a chip or chip-set implementing the central-office modem (ATU-C) end or the customer premise equipment modem (ATU-R) end of an ADSL link, or the optical network unit end (VTU-O) or remote end (VTU-R) of a DMT-based VDSL link. It is to-be appreciated that the instruction mechanism can be used in other contexts where data must be DMT encoded in the same way, including systems not implementing DSL, for example in COFDM transmission as used for digital broadcasting.

In general, the present invention uses a first input operand comprising a plurality of bit-group data values to be encoded for one of the plurality of tones; uses a second input operand comprising a plurality of bit-group size values corresponding to the bit-group data values in the first input operand; and generates an output comprising a result of encoding the bit-group data values from the first input operand by mapping the bit-group data values from the first input operand onto a constellation as determined by the corresponding bit-group size values from the second input operand. In one aspect, the first and second input operands each comprise a plurality of lanes, each lane comprising a number of bits. Each lane in the first input operand comprises a bit-group data value, and each lane in the second input operand comprises a bit-group size value corresponding to a bit-group data value in the first input operand. The number of bits per lane may vary and in one embodiment, each lane comprises 16 bits. The output of the present invention may further comprise a plurality of lanes, each lane comprising the result of encoding the bit-group data values from the first input by mapping the bit-group data values from the first input operand onto a constellation as determined by the corresponding bit-group size values from the second input operand. In one embodiment, each lane in the output comprises 32 bits. Each lane in the output may be further divided into two sub-fields, wherein a first sub-field represents an X coordinate of a point in the determined constellation and a second sub-field represents a Y coordinate of the point in the determined constellation.

In another embodiment, the first input operand comprises one lane for one bit-group data value and the second input operand comprises one lane for one bit-group size value corresponding to the one bit-group data value, and generates an output comprising a result of encoding the bit-group data value by mapping it onto a constellation as determined by the bit-group size value. In this embodiment, the present invention performs the DMT encoding for one bit-group data value for one tone.

In a preferred embodiment, the DMT encoding instruction mechanism takes as one input a 64-bit value including four 16-bit (“half-word”) fields (also called lanes) numbered 0 . . . 3 comprising bit-group data values to be encoded and a second input comprising 64 bits in size including four fields (numbered 0 . . . 3) which define the size of the bit-group data values in corresponding fields 0 . . . 3 of the first input, and encodes the corresponding bit-group data field from the first input, by mapping it onto a particular constellation as determined by the corresponding bit-group size field from the second input. For each of the four bit-group data fields, the corresponding 32-bit tone-field lane in the output contains the 2-dimensional (X, Y) location of the mapped point in the chosen constellation. In this embodiment, the output can comprise two 64-bit fields, each 64-bit field comprising two 32-bit tone-fields, for a total of four 32-bit tone-fields.

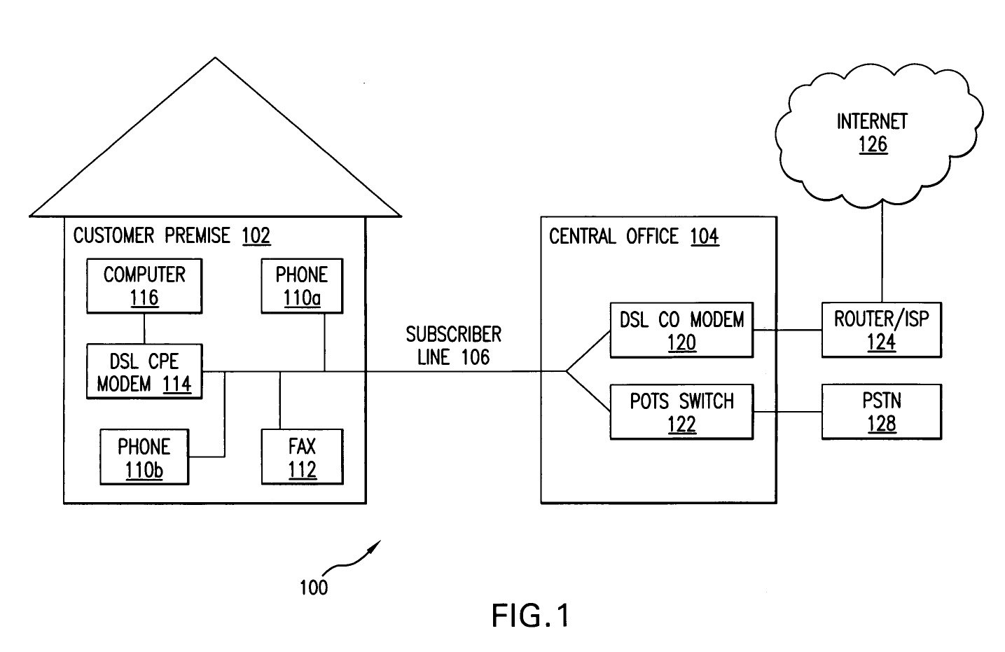

Embodiments of the invention are discussed below with references to FIGS. 1 to 3. However, those skilled in the art will readily appreciate that the detailed description given herein with respect to these figures is for explanatory purposes as the invention extends beyond these limited embodiments.

Referring now to FIG. 1, there is shown a block diagram of a communications system 100 in accordance with one embodiment of the present invention. System 100 provides traditional voice telephone service (plain old telephone service—POTS) along with high speed Internet access between a customer premise 102 and a central office 104 via a subscriber line 106. At the customer premise end 102, various customer premise devices may be coupled to the subscriber line 106, such as telephones 110a, 110b, a fax machine 112, a DSL CPE (Customer Premise Equipment) modem 114 and the like. A personal computer 116 may be connected via DSL CPE modem 114. At the central office end 104, various central office equipment may be coupled to the subscriber line 106, such as a DSL CO (Central Office) modem 120 and a POTS switch 122. Modem 120 may be further coupled to a router or ISP 124 which allows access to the Internet 126. POTS switch 122 may be further coupled to a PSTN 128.

In accordance with one embodiment of the present invention, system 100 provides for data to be sent in each direction as a data stream between the central office 104 and the customer premise 102 via subscriber line 106. As data is sent from the central office 104 to the customer premise 102, the DSL CO modem 120 at the central office 104 DMT encodes the data in accordance with the principles of the present invention before modulating and transmitting the data via subscriber line 106. Similarly, when data is sent from the customer premise 102 to the central office 104, the DSL CPE modem 114 at the customer premise 102 DMT encodes the data in accordance with the principles of the present invention before modulating and transmitting the data via subscriber line 106. In a preferred embodiment, DSL CO modem 120 incorporates a BCM6411 or BCM6510 device, produced by Broadcom Corporation of Irvine, Calif., to implement its various functions.

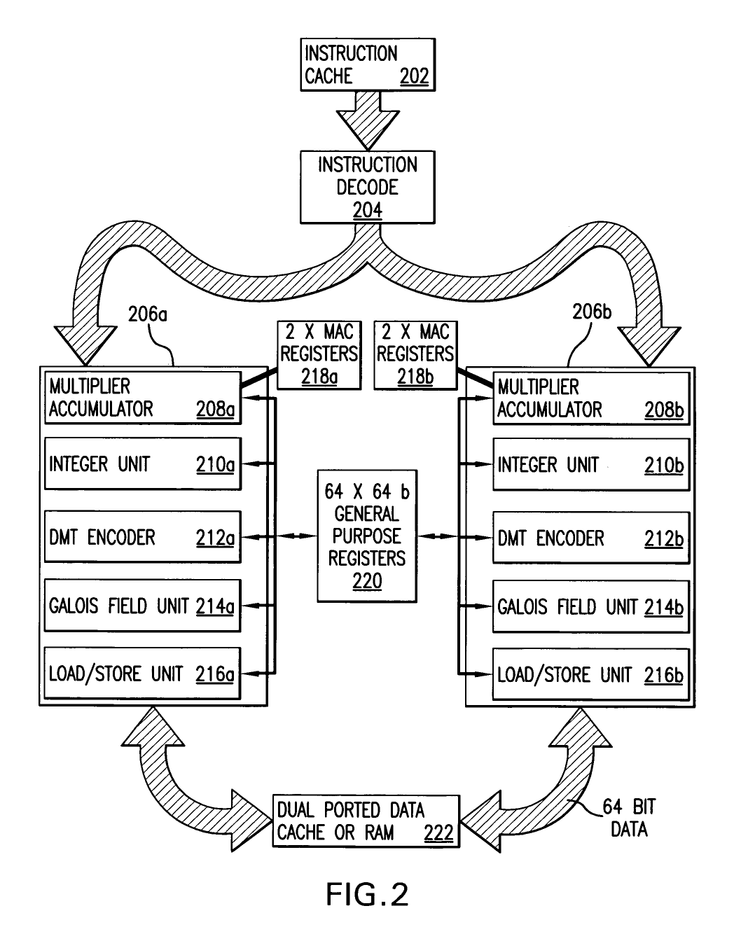

Referring now to FIG. 2, there is shown a schematic block diagram of the core of a modem processor 200 in accordance with one embodiment of the present invention. In a preferred embodiment, processor 200 is the Broadcom FirePath processor used in the BCM6411 and BCM6510 devices. The processor 200 is a 64 bit long instruction word (LIW) machine consisting of two execution units 206a, 206b. Each unit 206a, 206b is capable of 64 bit execution on multiple data units, (for example, four 16 bit data units at once), each controlled by half of the 64 bit instruction. The execution units, 206a, 206b, may include single instruction, multiple data (SIMD) units.

SIMD stands for “Single Instruction Multiple Data” and describes a style of digital processor design in which a single instruction can be issued to control the processing of multiple data values in parallel (all being processed in the same manner). SIMD operations can be implemented in a digital processor, such as Broadcom's FirePath digital processor design, by data processing units which receive multiple input values, each 64 bits wide but capable of being logically subdivided into and treated as multiple smaller values e.g. 8×8-bit values, 4×16-bit values, or 2×32-bit values.

To illustrate SIMD working as used in FirePath, consider the FirePath instruction
ADDH c, a, b

The instruction mnemonic ADDH is an abbreviation for “Add Half-words.” The instruction “ADDH c, a, b” takes as input two 64-bit operands from registers a and b, and writes its result back to register c. ADDH performs four 16-bit (“half-word”) additions: each 16-bit value in a is added to the corresponding 16-bit value within b to produce 4×16-bit results in the 64-bit output value c. Thus, this SIMD method allows for a great increase in computational power compared with earlier types of processors where an instruction can only operate on a single set of input data values (e.g. one 16-bit operand from a, one 16-bit operand from b giving one 16-bit result in c). For situations where the same operation is to be performed repeatedly across an array of values, which is common in digital signal processing applications, it allows in this instance an increase in speed by a factor of four of the basic processing rate, since four add operations can be performed at once rather than only one.

Processor 200 also includes an instruction cache 202 to hold instructions for rapid access, and an instruction decoder 204 for decoding the instruction received from the instruction cache 202. Processor 200 further includes a set of MAC Registers 218a, 218b, that are used to improve the efficiency of multiply-and-accumulate (MAC) operations common in digital signal processing, sixty four (or more) general purpose registers 220 which are preferably 64 bits wide and shared by execution units 206a, 206b, and a dual ported data cache or RAM 222 that holds data needed in the processing performed by the processor. Execution units 206a, 206b further comprise multiplier accumulator units 208a, 208b, integer units 210a, 210b, DMT encoder units 212a, 212b, Galois Field units 214a, 214b, and load/store units 216a, 216b.

Multiplier accumulator units 208a, 208b perform the process of multiplication and addition of products (MAC) commonly used in many digital signal processing algorithms such as may be used in a DSL modem.

Integer units 210a, 210b, perform many common operations on integer values used in general computation and signal processing.

Galois Field units 214a, 214b perform special operations using Galois field arithmetic, such as may be executed in the implementation of the well-known Reed-Solomon error protection coding scheme.

Load/store units 216a, 216b perform accesses to the data cache or RAM, either to load data values from it into general purpose registers 220 or store values to it from general purpose registers 220. They also provide access to data for transfer to and from peripheral interfaces outside the core of processor 200, such as external data interfaces for data of various types.

DMT encoding units 212a, 212b directly implement the DMT encoding process for the processor 200. These units may be instantiated separately within the processor 200 or may be integrated within another unit such as the integer unit 210. In one embodiment, each DMT encoding unit 212a, 212b receives a first input data value comprising a 64-bit value containing bit-group data values to be encoded and a second input data value comprising a 64-bit value defining the sizes of the bit-group data values in the first input data value. The DMT encoding unit then encodes the corresponding bit-group data value from the first input data value by mapping it onto a particular constellation as determined by the corresponding bit-group size field from the second input data value. The result contains a 2-dimensional (x,y) location of the mapped point in the chosen constellation.

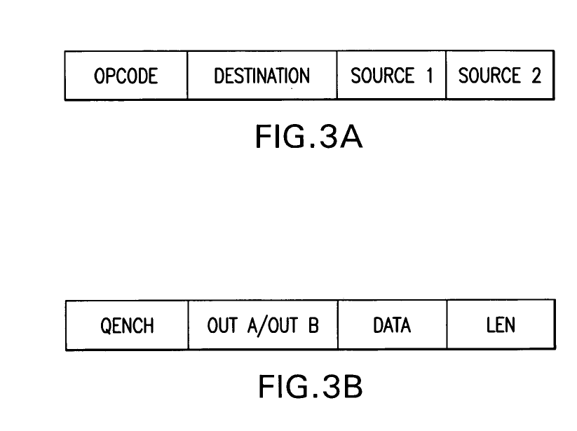

Referring now to FIG. 3A, there is shown an example of an instruction format for a three-operand instruction supported by the processor 200. In one embodiment, the instruction format includes 14 bits of opcode and control information, and three six-bit operand specifiers. As will be appreciated by one skilled in the art, exact details such as the size of the instruction in bits, and how the various parts of the instruction are laid out and ordered within the instruction format, are not themselves critical to the principles of present invention: the parts could be in any order as might be convenient for the implementation of the instruction decoder 204 of the processor 200 (including the possibility that any part of the instruction such as the opcode and control information may not be in a single continuous sequence of bits such as is shown in FIG. 3). The operand specifiers are references to registers in the set of general purpose registers 220 of processor 200. The first of the operands is a reference to a destination register or (a pair of) registers for storing the results of the instruction. In another embodiment, two separate destination operand specifiers might be used, one for each of two fields of the output of the instruction. The second operand is a reference to a first source register for the instruction, and the third operand is a reference to a second source register for the instruction.

Referring now to FIG. 3B, there is shown an example of a possible instruction format for DMT encoding data in accordance with mapping schemes specified in international or national standards supported by processor 200 in accordance to the present invention. Again it should be observed that exact details of how this instruction format is implemented—the size, order and layout of the various parts of the instruction, exact codes used to represent the opcode, etc.—are not critical to the principles of the present invention. The mnemonic for the opcode is shown here as “QENCH”, where QENCH stands for QAM-ENCode Halfwords; however, one skilled in the art will appreciate that the name for the opcode used in this description is incidental and any name could be chosen for it. The QENCH instruction uses the three-operand instruction format shown in FIG. 3A, and in one embodiment, is defined to take three six-bit operand specifiers. The first of the operands is a reference to a pair of destination registers for an output “outa/outb” where the results of the QENCH instruction are stored. The second operand is a reference to a first source register for a first input “data” from which data is read, and the third operand is a reference to a source register for the second input “len” from which the sizes of the corresponding bit-groups in “data” are read. One skilled in the art will realize that the present invention is not limited to any specific register or location for those registers but that the instruction of the present invention may refer to an arbitrary register in the general purpose registers 220.

Thus, by means of this generality of specification, the present invention advantageously achieves great flexibility in the use of the invention. For example, the present invention enables the original data, which is to be DMT encoded, to be obtained from any location chosen by the implementor (e.g. by first loading that data from the memory 222, or from an external data interface connected via load/store units 216a, 216b, into any convenient register). Likewise, the resulting DMT encoded data may be placed anywhere convenient for further processing such as in some general purpose register 220 for immediate further operations, or the resulting DMT encoded data may be placed back in memory 222 for later use. Thus, the flexibility of the present invention is in sharp contrast to conventional (hardware) implementations of the DMT encoding function, where the data flow is fixed in an arrangement dictated by the physical movement of data through the hardware, and cannot be adapted or modified to suit different modes of use.

In one embodiment, the DMT encoding instruction is used in the software on a processor chip or chip-set implementing a central-office modem end of a DSL link (e.g. ADSL or DMT-based VDSL). However, one skilled in the art will realize that the present invention is not limited to this implementation, but may be equally used in other contexts where data must be DMT encoded in a substantially similar way, such as in a DSL CPE modem at the customer premise, or in systems not implementing DSL, e.g. in a COFDM transmitter used for digital broadcasting.

In one embodiment, the QENCH instruction takes as one input a 64-bit value including four 16-bit (“half-word”) fields (also known as lanes) numbered 0 . . . 3. Each half-word field contains a bit-group data value to be encoded for one tone, between 0 and 15 bits in size. In one embodiment, the bits representing the value may be aligned at the most-significant (left-hand) end of the 16-bit field, and lower bits of the field beyond the defined size are required to be zero for correct operation, using the detailed definition of this embodiment given below. However, one skilled in the art will realize that the principles of the present invention are not linked to this arrangement but that the data may be aligned in other ways. For example, another embodiment could have the bit-group data values in the first 64-bit input value being aligned instead to the least-significant (right-most) end of their respective 16-bit field, and ignore the bits to the left-hand (more significant) end, beyond the defined size. Alternatively, yet another embodiment could ignore the bits beyond the defined size, rather than requiring that they be zero. In one embodiment the second input operand is also 64 bits in size including four fields (numbered 0 . . . 3) each of 16 bits, which define the sizes of the bit-group values in the respective fields 0 . . . 3 of the first operand. As with the arrangement of data in the first input operand, one skilled in the art will realize that the arrangement of the bit-group size data is not limited to this description, but may be organized in other ways as well. For example, in one embodiment, the size information might be organized as four fields of 8-bits each, or of 4 bits each, with any remaining bits in the second operand being ignored. It will also be apparent that the principles of the present invention are applicable for other numbers of fields in each operand; for example, in a processor supporting 32-bit SIMD processing rather than 64-bit SIMD processing, the first and second input operands could each contain 2 fields (of 16 bits) rather than 4 such fields as is appropriate for a 64-bit processor. Conversely, a processor might support data operations wider than 64 bits (e.g. 128 bits) in which case more bit-groups (e.g. 8) could be DMT encoded at once. On the other hand, an embodiment could implement the present invention without using SIMD techniques, DMT encoding a single bit-group data value according to a single bit-group size value, for one tone at a time.

The output of the instruction is a 128-bit value, organized as a pair of 64-bit values and logically divided into four 32-bit tone fields (numbered 0 . . . 3). Each 32-bit tone field represents the result of encoding the corresponding bit-group data value from the first input operand, by mapping it onto a particular constellation as determined by the corresponding bit-group size field from the second input operand. The 32-bit result contains the 2-dimensional (X, Y) location of the mapped point in the chosen constellation. Each 32-bit tone field is further divided into two 16-bit coordinate sub-fields, where the first sub-field (least-significant 16 bits of the 32) represents the X coordinate of the constellation point and the second sub-field (most significant 16 bits of the 32) represents the Y coordinate. In another embodiment, the Y coordinate could occupy the first coordinate sub-field and the X coordinate the second coordinate sub-field. Again, as with the first and second input operands, one skilled in the art will realize that the present invention is not limited to the organization of the output described above, but may be organized in other ways as well.

In operation, the instruction mechanism is implemented in a processor, such that the instruction mechanism performs the DMT encoding process for a plurality of tones (such as 4 tones) in a single operation during one cycle. In contrast, conventionally a processor required at least 40 operations to DMT encode 4 tones. Therefore, the instruction mechanism of the present invention significantly increases efficiency of DMT encoding of data for subsequent modulation and transmission.

The core operation performed by the QENCH instruction mechanism implementing 16-bit lanes for the first and second input operands can be described by the following abstract logic description:
outa.<31 . . . 0>=QENCH_lane(data.<15 . . . 0>, len.<3 . . . 0>)
outa.<63 . . . 32>=QENCH_lane(data.<31 . . . 16>, len.<19 . . . 16>)
outb.<31 . . . 0>=QENCH_lane(data.<47 . . . 32>, len.<35 . . . 32>)
outb.<63 . . . 32>=QENCH_lane(data.<63 . . . 48>, len.<51 . . . 48>)

QENCH_lane(dataLane,lenLane) defines the operation on each respective 16-bit lane from the two input operands to create a 32-bit field of the generated result. In one embodiment, only the least significant 4 bits of each 16-bit lane from the ‘len’ operand are in fact used. In this embodiment, the other bits are ignored.

out=QENCH_lane(data,len) is the individual operation on each lane of the 4-way SIMD instruction. To match the usage of the operation in the full definition of QENCH: (1) the parameter data here refers only to a 16-bit field selected from the original 64-bit data operand to the full QENCH instruction; (2) the parameter len (i.e. the bit-group size value) similarly refers to a corresponding 4-bit field selected from the original 64-bit len operand; (3) out is a temporary 32-bit value which contains the result of one instance of the QENCH_lane operation; (4) index is a temporary 5-bit value; and (5) outx, outy and offset are temporary 9-bit values, as shown by the following:

```
out.<6..0>  = ZEROS(7)
out.<22..16> = ZEROS(7)
if (len = 1) {
    out.<15..7>  = SEQ(data.15,1,data.{12,10,8,6,4,2},0)
    out.<31..23> = SEQ(data.15,1,data.{11, 9,7,5,3,1},0)
} else if (len = 3) {
    index = SEQ(data.{15,14,13},NOT(data.13),NOT(data.13))
    out.<15..7>  = SEQ(TabX[index].{1,0},1,data.{10,8,6,4,2},0)
    out.<31..23> = SEQ(TabY[index].{1,0},1,data.{ 9,7,5,3,1},0)
} else {
    if (len.0 = 1) {
    outx = SEQ(TabX[data.<15..11>].{1,0},data.{12,10,8,6,4,2},0)
    outy = SEQ(TabY[data.<15..11>].{1,0},data.{11,
        9,7,5,3,1},0)
    } else {
        outx = SEQ(data.{15,13,11,9,7,5,3},0,0)
        outy = SEQ(data.{14,12,10,8,6,4,2},0,0)
    }
    if (len = 0) {
        offset = ZEROS(9)
    } else {
    offset = ONEBIT(9,(16 − len).<3..1>)
    }
    out.<15..7> = outx | offset
    out.<31..23> = outy | offset
}
return out
```

Within the definition of QENCH_lane, the tables TabX and TabY are used. These are each an array of 32×2-bit constant values. A 5-bit value is used to select the required entry from each table. For example, value 0 selects the first entry, value 1 the second, etc. The values in these tables are derived directly from the equivalent table in the DSL standards for the mapping of odd-sized bit-groups onto their constellations. For example:

TabX is [0,0,0,0,0,0,0,0,3,3,3,3,3,3,3,3,1,1,2,2,0,0,0,0,3,3,3,3,1,1,2,2]
TabY is [0,0,0,0,3,3,3,3,0,0,0,0,3,3,3,3,0,0,0,0,1,2,1,2,1,2,1,2,3,3,3,3]

In the above descriptions the following definitions apply:
val.n (where val identifies a linear bit sequence of one or more bits and n is a constant) means bit n of value val, bit 0 is the least significant bit, and bit 1 is the next more significant bit, etc.
val.{i,j,k, . . . } is a shorthand way of writing val.i, val j, val.k, . . .
SEQ(a,b, . . . z) means the linear bit sequence resulting from the concatenation of the listed bit values a, b, . . . z, where bit a becomes the most significant bit, b the next most significant bit, etc, and z the least significant bit of the resulting sequence. The length of the sequence is equal to the number of bit values in the list.
ZEROS(s) means the linear bit sequence of length s in which all bits are 0.
ONEBIT(s,p) means the linear bit sequence of length s in which all bits are 0 except bit p which is 1. It is required that 0 □ p □ s-1.
val.<m . . . n> where m and n are constants or constant expressions and m≧n, means the linear bit sequence SEQ(val.m, val.(m-1), . . . val.n).
NOT(val) means the binary complement of each bit of value val, e.g. if val is a single bit then NOT(val) has value 0 iff val is 1 and vice versa; e.g. if val is a sequence of length 4 and value 6 then NOT(val) is a sequence of length 4 and value 9
vail1 val2 means the combination of the linear bit sequence val1 with linear bit sequence val2 using the logical “or” operator, in which bit n of the result is equal to the logical OR of bit n of val1 with bit n of val2. The two sequences must be of the same length.
val1-val2 means the combination of the linear bit sequence val1 with linear bit sequence val2 by subtraction; each of vai1 and val2 is considered as the 2's complement binary-coded representation of an integer, and the result is the binary coded representation of the value of val1 minus the value of val2.

The above abstract logic description is only one of many possible ways to define logic circuitry to achieve the desired function. The logical combination of the various input bits to produce the output bits can be defined in other ways. Therefore, the above abstract logic description is given by way of example only, and other descriptions can be used as well.

One way in which the current invention may be implemented in the context of a semiconductor chip is by use of logic synthesis tools (such as the software program ‘BuildGates’ by Cadence Design Systems, Inc.) to create a logic circuit implementing the core function of the QENCH instruction as defined above. Such tools take as input a high-level definition in a formal definition language such as Verilog or VHDL; such languages have a general character comparable to the above abstract logic description, though differing in detail. A skilled artisan can readily use the above abstract logic description to create such a high-level definition and thereby create a logic circuit using such tools.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for performing DMT encoding substantially simultaneously on at least one tone, the method comprising:
(a) using a first input operand comprising at least one bit-group data value to be DMT encoded for the at least one tone;
(b) using a second input operand comprising at least one bit-group size value corresponding to the at least one bit-group data value in the first input operand; and
(c) generating an output comprising a result of DMT encoding the bit-group data value or values from the first input by mapping the bit-group data value or values from the first input operand onto a constellation as determined by the corresponding bit-group size value from the second input operand.

2. The method of claim 1, wherein the first and second input operands each comprise at least one lane, each lane in the first input operand comprising a bit-group data value, and each lane in the second input operand comprising a bit-group size value.

3. The method of claim 2, wherein each lane in the first input operand comprises 16 bits, and each lane in the second operand comprises 16 bits or 8 bits or 4 bits.

4. The method of claim 1, wherein the bit-group size value or values defined in the second input operand each vary from 0 to 15.

5. The method of claim 1, wherein the method performs DMT encoding substantially simultaneously on four tones.

6. The method of claim 1, wherein the output further comprises at least one lane, each lane comprising the result of DMT encoding a bit-group data value from the first input by mapping the bit-group data value from the first input operand onto a determined constellation as determined by the corresponding bit-group size value from the second input operand.

7. The method of claim 6, wherein each lane in the output comprises 32 bits.

8. The method of claim 6, wherein each lane in the output comprises a 2-dimensional (X, Y) location of the mapped point in the determined constellation.

9. The method of claim 6, wherein each lane is further divided into two sub-fields, wherein a first sub-field represents an X coordinate of a point in the determined constellation and a second sub-field represents a Y coordinate of the point in the determined constellation.

10. A method for executing a single instruction DMT encoding on a processor, the method comprising:
providing the processor with an opcode indicating a DMT encoding instruction;
providing the processor with a first input data value;
providing the processor with a second input data value;
providing the processor with a reference to a destination register or registers of the processor;
DMT encoding the first input data value using the second data input value to create a DMT encoded output value; and
storing the DMT encoded output value in the destination register or registers.

11. The method of claim 10 wherein the DMT encoding is performed substantially simultaneously on a plurality of tones for the first input data value.

12. The method of claim 10 wherein the first input data value comprises a plurality of lanes, each lane comprising a bit-group data value to be DMT encoded for one of the plurality of tones.

13. The method of claim 10 wherein the second input data value comprises a plurality of lanes, each lane comprising a bit-group size value corresponding to a bit-group data value in the first input data value.

14. The method of claim 12 or 13, wherein each lane of the first operand comprises 16 bits and each lane of the second operand comprises 16 bits or 8 bits or 4 bits.

15. The method of claim 10 wherein the output value comprises a plurality of lanes, each lane representing a result of DMT encoding a corresponding bit-group data value from the first input data value by mapping the bit-group data value from the first input data value onto a determined constellation as determined by the bit-group size values from the second input data value.

16. The method of claim 15, wherein each lane in the output comprises 32 bits.

17. The method of claim 10 wherein the method is used in a chip or chip-set implementing a central-office modem end of a DSL link.

18. The method of claim 10 wherein the method is used in a chip or chip-set implementing a customer premise equipment modem end of a DSL link.

19. The method of claim 13 wherein the bit-group size value varies from 0 to 15.

20. The method of claim 15 wherein each lane of the output comprises a 2-dimensional (X, Y) location of the mapped point in the determined constellation.

21. The method of claim 15 wherein each lane is further divided into two sub-fields, wherein a first sub-field represents an X coordinate of a point in the determined constellation and a second sub-field represents a Y coordinate of the point in the determined constellation.

22. A method of operating a processor comprising:
in response to a single instruction executable by the processor, performing DMT encoding substantially simultaneously on a plurality of tones.

23. The method of claim 22 wherein the instruction receives a first input data value comprising a plurality of lanes, each lane comprising a bit-group data value to be DMT encoded for one of the plurality of tones.

24. The method of claim 22 wherein the instruction receives a second input data value comprising a plurality of lanes, each lane comprising a bit-group size value corresponding to a bit-group data value in the first input data value.

25. The method of claim 23 or 34, wherein each lane of the first operand comprises 16 bits and each lane of the second operand comprise 16 bits or 8 bits or 4 bits.

26. The method of claim 22 wherein the instruction outputs an output value comprising a plurality of lanes, each lane representing a result of DMT encoding a corresponding bit-group data value from the first input data value by mapping the bit-group data value from the first input data value onto a determined constellation as determined by the bit-group size values from the second input data value.

27. The method of claim 26, wherein each lane in the output comprises 32 bits.

28. The method of claim 22 wherein the method is used in a chip or chip-set implementing a central-office modem end of a DSL link.

29. The method of claim 22 wherein the method is used in a chip or chip-set implementing a customer premise equipment modem end of a DSL link.

30. The method of claim 24 wherein the bit-group size value varies from 0 to 15.

31. The method of claim 26 further comprising the step of providing each of the lanes of the output with a 2-dimensional (X, Y) location of the mapped point in the determined constellation.

32. The method of claim 26 further comprising the step of dividing each lane of the output into two sub-fields, wherein a first sub-field represents an X coordinate of a point in the predetermined constellation and a second sub-field represents a Y coordinate of the point in the predetermined constellation.

33. The method of claim 22 wherein the processor is a 64-bit long instruction word machine comprising two execution units.

34. A processor comprising:
a plurality of registers; and
at least one execution unit configured to DMT encode one or more bits of data in response to a single instruction executable by the processor.

35. The processor of claim 34 wherein the instruction receives a first input data value comprising a plurality of lanes, each lane comprising a bit-group data value to be DMT encoded.

36. The processor of claim 34 wherein the instruction receives a second input data value comprising a plurality of lanes, each lane comprising a bit-group size value corresponding to a bit-group data value in the first input data value.

37. The processor of claim 35 or 36, wherein each lane comprises 16 bits.

38. The processor of claim 34 wherein the instruction outputs an output value comprising a plurality of lanes, each lane representing a result of DMT encoding a corresponding bit-group data value from the first input data value by mapping the bit-group data value from the first input data value onto a determined constellation as determined by the bit-group size values from the second input data value.

39. The processor of claim 38, wherein each lane in the output comprises 32 bits.

40. The processor of claim 36 wherein the bit-group size value varies from 0 to 15.

41. The processor of claim 38 further comprising the step of providing each of the lanes of the output with a 2-dimensional (X, Y) location of the mapped point in the determined constellation.

42. The processor of claim 38 further comprising the step of dividing each lane into two sub-fields, wherein a first sub-field represents an X coordinate of a point in the predetermined constellation and a second sub-field represents a Y coordinate of the point in the predetermined constellation.

43. The processor of claim 34 wherein the processor is a 64-bit long instruction word machine comprising two execution units.

44. The processor of claim 34 wherein the processor is used in a chip or chip-set implementing a central-office modem end of a DSL link.

45. The processor of claim 34 wherein the processor is used in a chip or chip-set implementing a customer premise equipment modem end of a DSL link.

46. An apparatus comprising:
a processor;
a plurality of registers accessible to the processor; and
means for DMT encoding one or more bits of data in response to a single instruction executable by the processor.

47. The apparatus of claim 46 wherein the instruction receives a first input and a second input, and produces as output DMT encoded data.

48. The apparatus of claim 47 wherein the instruction receives a first input data value comprising a plurality of lanes, each lane comprising a bit-group data value to be DMT encoded for one of a plurality of tones.

49. The apparatus of claim 47 wherein the instruction receives a second input data value comprising a plurality of lanes, each lane comprising a bit-group size value corresponding to a bit-group data value in the first input data value.

50. The apparatus of claim 48 or 49, wherein each lane of the first input data value comprises 16 bits and each lane of the second input data value comprises 16 bits or 8 bits or 4 bits.

51. The apparatus of claim 47 wherein the instruction outputs an output value comprising a plurality of lanes, each lane representing a result of DMT encoding a corresponding bit-group data value from the first input data value by mapping the bit-group data value from the first input data value onto a determined constellation as determined by the bit-group size values from the second input data value.

52. The apparatus of claim 51, wherein each lane in the output comprises 32 bits.

53. The apparatus of claim 49 wherein the bit-group size value varies from 0 to 15.

54. The apparatus of claim 44 further comprising the step of dividing each lane into two sub-fields, wherein a first sub-field represents an X coordinate of a point in the predetermined constellation and a second sub-field represents a Y coordinate of the point in the predetermined constellation.

55. The apparatus of claim 46 wherein the processor is a 64-bit long instruction word machine comprising two execution units.

56. The apparatus of claim 46 wherein the processor is used in a chip or chip-set implementing a central-office modem end of a DSL link.

57. The apparatus of claim 46 wherein the processor is used in a chip or chip-set implementing a customer premise equipment modem end of a DSL link.

58. A computer program product including software for execution as at least one thread on a processor that executes an instruction set that includes a DMT encoding instruction that upon execution thereof, causes the processor to DMT encode data represented in a first source register and a second source register to a resulting DMT encoded data; the computer program product comprising:
at least one instance of the DMT encoding instruction.
